(19) United States
(12) Patent Application Publication
(10) Pub. No.: US 2005/0243487 A1
(43) Pub. Date: Nov. 3, 2005

(54) SWITCHABLE POWER SUPPLY SYSTEM AND METHOD THEREOF

(76) Inventors: Yung-Lung Chen, Taipei (TW); Yuan-Tung Peng, Hsinchu City (TW); Nelson Bao, Kaohsiung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/908,026

(22) Filed: Apr. 26, 2005

(30) Foreign Application Priority Data
Apr. 30, 2004 (TW) 93112148

(51) Int. Cl. H02H 3/00

(52) U.S. Cl. 361/64

(57) ABSTRACT

A switchable power supply system and a method thereof is provided. The power supply system includes a power supply and a control circuit. The power supply has a power output terminal connected to a load. The power output terminal provides the load with a first power source or a second power source. The control circuit is disposed in the power supply and connected to the power output terminal for detecting the operation mode of the load. When the load is in a predetermined operating mode, the power supply is forced to provide the power output terminal with the first power source. Otherwise, the control circuit will automatically switch the power supply system to provide the power output terminal with the first power source or the second power source according to the status of the load.

### CROSS-REFERENCE TO RELATED APPLICATION

This application claims the priority benefit of Taiwan application serial no. 93112148, filed on Apr. 30, 2004. All disclosure of the Taiwan application is incorporated herein by reference.

### BACKGROUND OF THE INVENTION

1. Field of the Invention

The present invention relates to a power supply system and a power supplying method thereof. More particularly, the present invention relates to a power supply system with switchable operating mode and a switching method thereof.

2. Description of the Related Art

Power supply is an important component in most electronic products. In general, a DC-to-DC power supply system is used in most portable electronic devices including notebook, mobile phone, cellular phone, pager, personal digital assistant (PDA), smart phone or other product with bluetooth function. FIG. 1 is a schematic circuit diagram of a conventional DC-to-DC power supply system. As shown in FIG. 1, a conventional DC-to-DC power supply system 100 includes an inductor 102, a transistor 104, a diode 106 and a capacitor 108. One terminal of the inductor 102 is connected to a power input terminal and the other terminal of the inductor 102 is connected the transistor 104. The gate of the transistor 104 is connected to a control terminal and the source/drain terminals are connected to the inductor 102 and ground respectively. One terminal of the diode 106 is connected to the inductor 102 and the other terminal of the diode 106 is connected to a power output terminal. One terminal of the capacitor 108 is connected to the power output terminal and the other terminal of the capacitor 108 is connected to the ground. The power output terminal is capable of sending output power to a load 110.

FIG. 2 is a diagram illustrating the powering modes provided by a conventional DC-to-DC power supply system. As shown in FIG. 2, the output voltage Vout is the voltage at the voltage output terminal and the inductor current is the current flowing through the inductor 102 shown in FIG. 1. The DC-to-DC power supply system 100 in FIG. 1 is operated as the following steps. First, the inductor 102 receives an input power from the input terminal. When the control terminal turns on the gate of the transistor 108, a current flows from the input power source to the ground. When the transistor 108 is turned off, the current flows from the input power source through the inductor 102 and the diode 106 to the voltage output terminal and being stored in the capacitor 108. As shown in FIG. 2, in any one of the operating modes, the transistor 108 will turn off when the output voltage Vout drops to a voltage close to the low voltage V2. Therefore, a current will flow from the input terminal to the output terminal through the inductor 102 so that the inductor current rises gradually. Thereafter, the inductor current is maintained at a peak value for a period of time. During this period, the capacitor 108 is charged so that the output voltage Vout rises gradually. When the output voltage Vout rises to a voltage close to the peak level V1, the gate of the transistor 108 turns on so that the inductor current starts to drop again. After the output voltage Vout has risen to the peak voltage V1, the inductor current will maintain at the smallest value for a period of time. Thereafter, the capacitor 108 begins to discharge through the load 110 so that the output voltage Vout will drop gradually.

In FIG. 2, the time wherein the smallest inductor current is maintained is defined as Toff and the time of the inductor current dropping from the peak to the smallest inductor current is defined as Ton. The time T of the inductor current is the sum of Ton and Toff. In general, the type of power operating modes provided by the DC-to-DC power supply system 100 may be classified into pulse frequency modulation (PFM) and pulse width modulation (PWM). In the pulse frequency modulation (PFM) mode, the cycle time T can be modulated, where the inverse of the cycle time T is the operating frequency. In other words, the pulse frequency can be changed. In the pulse width modulation (PWM) mode, the cycle time T is fixed while the interval Ton (or interval Toff) can be modulated. In other words, the pulse width can be changed. Typically, in a pulse frequency modulation (PFM) mode, the inductor current has a lower frequency and a larger transient current operating and hence an output voltage Vout with a larger ripple is produced. In a pulse width modulation (PWM) mode, the inductor current has a higher frequency and a smaller transient current and hence an output voltage Vout with a smaller ripple is produced.

In some portable electronic devices such as mobile phones, radio frequency emitters are commonly adopted for communication. However, the output current from a conventional DC-to-DC power supply system may generate noise, and then the noise will interfere the transmission of the radio frequency. In general, a severe output power interference is generated in the pulse frequency modulation (PFM) node due to a lower operating frequency. Nevertheless, the user has to select the preferred operating mode according to the load. Conventionally, pulse frequency modulation (PFM) mode with a larger output voltage Vout ripple may be used when the load is light. Alternatively, pulse width modulation (PWM) mode with a smaller output voltage Vout ripple may be used when the load is heavy. At present, the convention technique only permits a switching of the operating mode according to the size of the load but does not permit a selection of the operating mode according to the operation status. Thus, a power supply system capable of switching to pulse width modulation mode when the system is operated in radio frequency mode and allowed for automatically switching of operating mode according to the size of loading when the system is not operated in radio frequency mode is desired.

### SUMMARY OF THE INVENTION

Accordingly, the present invention is directed to provide a switchable power supply system suitable for providing a power source with a pulse width modulation (PWM) mode when the load is operated in a radio frequency emission mode, and for automatically switching the power source according to the size of the load when the load is not operated in a radio frequency emission mode.

In addition, the present invention is directed to provide a switchable power supply method suitable for providing a power source with a pulse width modulation (PWM) mode when the load is operated in a radio frequency emission mode, and for automatically switching the power source according to the size of the load when the load is not operated in a radio frequency emission mode.

According to one embodiment of the invention, a switchable power supply system comprising a power supply and a control circuit is provided. The power supply has a power output terminal connected to a load. The power output terminal provides the load with a first power source or a second power source. The control circuit is disposed in the power supply and connected to the power output terminal for detecting the operation mode of the load. When the load is in a predetermined operating mode, the power supply is forced to provide the power output terminal with the first power source. Otherwise, the control circuit will automatically switch the power supply system to provide the power output terminal with the first power source or the second power source according to the status of the load.

In one embodiment of the present invention, the power supply comprises a DC-to-DC power supply.

In one embodiment of the present invention, the predetermined operating mode comprises a radio frequency emission mode.

In one embodiment of the present invention, the first power source comprises a pulse width modulation (PWM) mode and/or the second power source comprises a pulse frequency modulation (PFM) mode.

In one embodiment of the present invention, the status of the loads comprises the size of the load.

In addition, according to one embodiment of the present invention, a switchable power supply system comprising a power supply and a control circuit is provided. The power supply has an power input terminal connected to a load. The power output terminal provides the load with a first power source or a second power source. The control circuit is disposed in the power supply and connected to the power output terminal for detecting the operation mode of the load. When the load is in a radio frequency emission mode, the power supply is forced to provide the power output terminal with the first power source. Otherwise, the control circuit will automatically switch the power supply system to provide the power output terminal with the first power source or the second power source according to the status of the load. Furthermore, the first power source has a higher operating frequency than the second power source.

In one embodiment of the present invention, the power supply comprises a DC-to-DC power supply.

In one embodiment of the present invention, the first power source comprises a pulse width modulation (PWM) mode and/or the second power source comprises a pulse frequency modulation (PFM) mode.

In one embodiment of the present invention, the status of the load comprises the size of the load.

Moreover, according to one embodiment of the present invention, a switchable power supply method comprising the following steps is provided. When a load is in a predetermined operating mode, the power output terminal of a power supply system is forced to provide the load with a first power source. Otherwise, the power supply system detects the status of the load through the power output terminal. Thereafter, according to the status of the load, the power output terminal provides the load with the first power source or a second power source.

In one embodiment of the present invention, the power supply comprises a DC-to-DC power supply.

In one embodiment of the present invention, the predetermined operating mode comprises a radio frequency emission mode.

In one embodiment of the present invention, the first power source comprises a pulse width modulation (PWM) mode and/or the second power source comprises a pulse frequency modulation (PFM) mode.

In one embodiment of the present invention, the status of the load comprises the size of the load.

Furthermore, according to one embodiment of the present invention, an switchable power supply method comprising steps is provided. When a load is in a radio frequency emission mode, the power output terminal of a power supply system is forced to provide the load with a first power source. Otherwise, the power supply system detects the status of the load through the power output terminal. Thereafter, according to the status of the load, the power output terminal provides the load with the first power source or a second power source. Furthermore, the first power source has an operating frequency higher than the second power source.

In one embodiment of the present invention, the power supply comprises a DC-to-DC power supply.

In one embodiment of the present invention, the first power source comprises a pulse width modulation (PWM) mode and/or the second power source comprises a pulse frequency modulation (PFM) mode.

In one embodiment of the present invention, the status of the load comprises the size of the load.

Accordingly, the present invention provides a switchable power supply system and a switchable power supply method suitable for forcing the power supply to operate in a higher frequency power operating mode (for example, pulse width modulation (PWM) mode) when the load is operated in a radio frequency emission mode. Otherwise, the operating mode of the power supply is automatically selected according to the size of the load. Consequently, when the load is operated in a radio frequency emission mode, the noise generated by the power supply is reduced, and thus the interference with the radio emission is also reduced. On the other hand, when the load is not operated in the radio frequency emission mode, an appropriate operating mode can be selected based on the size of the load. Therefore, the energy conversion is more efficiently and the power consumption is reduced.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a schematic circuit diagram of a conventional DC-to-DC power supply system.

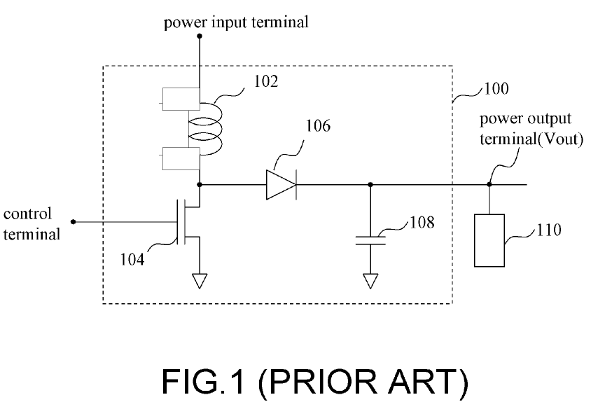

FIG. 2 is a diagram illustrating the powering modes provided by a conventional DC-to-DC power supply system.

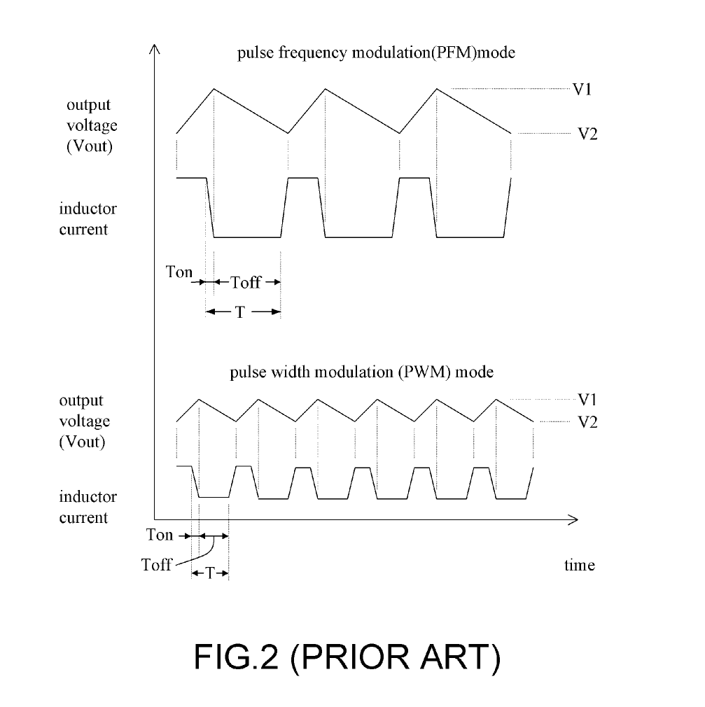

FIG. 3 is a schematic circuit diagram of a DC-to-DC power supply system according to one embodiment of the present invention.

### DESCRIPTION OF THE EMBODIMENTS

The present invention will be described fully hereinafter with reference to the accompanying drawings, in which preferred embodiments of the present invention are illustrated. The present invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements in the accompanying drawings throughout.

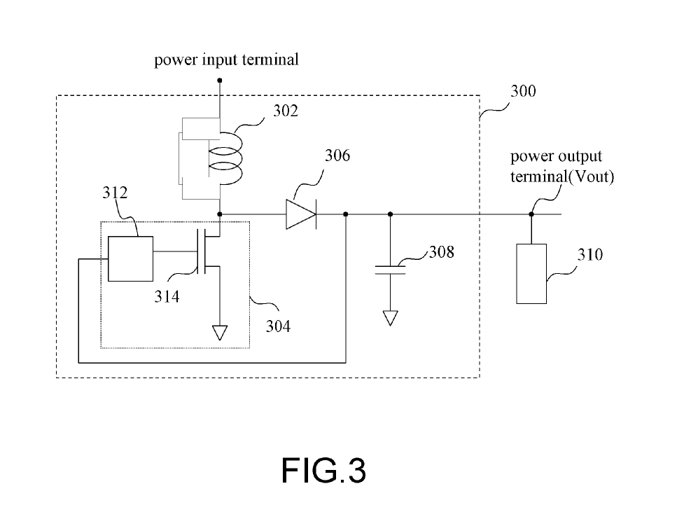

FIG. 3 is a schematic circuit diagram of a DC-to-DC power supply system according to one embodiment of the present invention. As shown in FIG. 3, a DC-to-DC power supply system 300 comprises an inductor 302, a control circuit 304, a diode 306 and a capacitor 308. One terminal of the inductor 302 is connected to an power input terminal and the other terminal of the inductor 302 is connected to the control circuit 304. One terminal of the diode 306 is connected to a power output terminal. One terminal of the capacitor 308 is connected to the power output terminal and the other terminal of the capacitor 308 is connected to ground. The power output terminal provides power to a load 310. The control circuit 304 is connected to the inductor 302, the diode 306 and the power output terminal. The control circuit 304 is able to control the current flowing from the inductor 302 to the diode 306 and detect the relationship between the power at the power output terminal and the load so that an appropriate powering mode can be selected.

In one embodiment of the present invention, when the control circuit 304 detects that the load is operated under a radio frequency emission, the control circuit 204 will force the power supply to provide a pulse width modulation (PWM) operating mode. Alternatively, the control circuit 304 will automatically select an appropriate operating mode according to the size of the load when the control circuit 304 detects that the load is not operated under a radio frequency emission. For example, if the load is heavy, the pulse frequency modulation (PFM) mode is used. Alternatively, if the load is light, the pulse width modulation (PWM) mode is used.

In another embodiment of the present invention, the control circuit 304 may further comprises a control unit 312 and a transistor 314. The control unit 312 is connected to the power output terminal for detecting the status between the output power at the power output terminal and the load. The gate of the transistor 314 is connected to the control unit 312 and the source/drain of the transistor 314 are connected to the inductor 302 and ground respectively. Similarly, when the control unit 312 detects that the load is operated under a radio frequency emission, the control unit 312 will force the power supply to be operated under a pulse width modulation (PWM) mode. When the load is not operated under a radio frequency emission, the control circuit 304 will automatically select an appropriate operation mode according to the size of the load. For example, the pulse frequency modulation (PFM) mode is used for heavy load and the pulse width modulation (PWM) mode is used for light load.

As shown in FIG. 3, the present invention also provides a switchable power supply system comprising a power supply 300 and a control circuit 304. The power output terminal of the power supply 300 is connected to a load 310. The power supply 300 provides a first power source or a second power source to the load 310. The control circuit 304 is disposed inside the power supply 30 and connected to the power output terminal for detecting the operating mode of the load 310. In the present embodiment, other electronic devices having a function similar to the inductor 302, the diode 306, the capacitor 308 can be used to replace thereof. When the control circuit 304 detects a predetermined operating mode in the load 310, the power output terminal of the power supply 300 is forced to provide the first power source. On the other hand, if the load 310 does not operated in a predetermined operating mode, the power output terminal switches automatically to provide the first power source or the second power source depending on the status of the load detected by the control circuit 304.

In another embodiment of the present invention, the power supply 300 includes a DC-to-DC power supply.

In another embodiment of the present invention, the predetermined operating mode includes a radio frequency emission mode.

In another embodiment of the present invention, the first power source comprises a pulse width modulation (PWM) operating mode and/or the second power source comprises a pulse frequency modulation (PFM) operating mode.

In another embodiment of the present invention, the status of the load of the load 310 includes the size of the load.

Referring to FIG. 3, the present invention also provides another switchable power supply system comprising a power supply 300 and a control circuit 304. The power supply 300 has a power output terminal connected to a load 310. The power supply 300 provides the power output terminal with a first power source or a second power source. The control circuit 304 is disposed inside the power supply 310 and connected to the power output terminal for detecting the operating mode of the load 310. In the present invention, other electronic devices having a function similar to the inductor 302, the diode 306, the capacitor 308 can be used to replace thereof. When the control circuit 304 detects that the load 310 is operated in a radio frequency emission mode, the power output terminal of the power supply 300 is forced to provide the first power source. On the other hand, if the load 310 is operated in a radio frequency emission mode, the power output terminal switches automatically to provide the first power source or the second power source depending on the status of the load detected by the control circuit 304. The first power source has an operating frequency higher than the second power source.

In another embodiment of the present invention, the power supply 300 includes a DC-to-DC power supply.

In another embodiment of the present invention, the first power source comprises a pulse width modulation (PWM) mode and/or the second power source comprises a pulse frequency modulation (PFM) mode.

In another embodiment of the present invention, the status of the load of the load 310 includes the size of the load.

As shown in FIG. 3, the present invention also provides a switchable power supply method. When the load 310 is operated in a predetermined operating mode, the power supply 300 is forced to provide the load 310 with the first power source. Alternatively, if the load 310 is not operated in a predetermined operating mode, the power output terminal is switched automatically to provide the first power source or the second power source according to the detected status of the load.

In another embodiment of the present invention, the power supply 300 includes, for example, a DC-to-DC power supply.

In another embodiment of the present invention, the predetermined operating mode includes, for example, a radio frequency emission mode.

In another embodiment of the present invention, the first power source comprises a pulse width modulation (PWM) mode and/or the second power source comprises a pulse frequency modulation (PFM) mode.

In another embodiment of the present invention, the status of the load 310 includes the size of the load.

As shown in FIG. 3, the present invention also provides another switchable power supply method. When the load 310 is operated in a radio frequency emission mode, the power supply 300 is forced to provide the load 310 with the first power source. Alternatively, if the load 310 is not operated in a radio frequency emission mode, the power output terminal is switched automatically to provide the first power source or the second power source according to the detected status of the load. Furthermore, the first power source has an operating frequency higher than the second power source.

In another embodiment of the present invention, the power supply 300 includes a DC-to-DC power supply.

In another embodiment of the present invention, the first power source comprises a pulse width modulation (PWM) operating mode and/or the second power source comprises a pulse frequency modulation (PFM) operating mode.

In another embodiment of the present invention, the status of the load 310 includes the size of the load.

Accordingly, the present invention provides a switchable power supply system and a switchable power supply method suitable for forcing the power supply to operate in a higher frequency power operating mode (for example, pulse width modulation (PWM) mode) when the load is operated in a radio frequency emission mode. Otherwise, the operating mode of the power supply is automatically selected according to the size of the load. Consequently, when the load is operated in a radio frequency emission mode, the noise generated by the power supply is reduced, and thus the interference with the radio emission is also reduced. On the other hand, when the load is not operated in the radio frequency emission mode, an appropriate operating mode can be selected based on the size of the load. Therefore, the energy conversion is more efficiently and the power consumption is reduced.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A switchable power supply method, comprising:
providing a load with a first power source from a power output terminal of a power supply system when the load is operated in a predetermined operating mode; and
switching the power output terminal of the power supply system to provide the load with the first power source or a second power source automatically according to a status of the load detected from the power output terminal of the power supply system when the load is not operated in the predetermined operating mode.

2. The method of claim 1, wherein the power supply system comprises a DC-to-DC power supply system.

3. The method of claim 1, wherein the predetermined operating mode comprises a radio frequency emission mode.

4. The method of claim 1, wherein the first power source comprises a pulse width modulation mode.

5. The method of claim 1, wherein the second power source comprises a pulse frequency modulation mode.

6. The method of claim 1, wherein the status of the load comprises the size of the load.

7. A switchable power supply method, comprising:
providing a load with a first power source from a power output terminal of a power supply system when the load is operated in a radio frequency emission mode; and
switching the power output terminal of the power supply system to provide the load with the first power source or a second power source automatically according to a status of the load detected from the power output terminal of the power supply system when the load is not operated in the radio frequency emission mode, wherein an frequency of the first power source is higher than a frequency of the second power source.

8. The method of claim 7, wherein the power supply system comprises a DC-to-DC power supply system.

9. The method of claim 7, wherein the first power source comprises a pulse width modulation mode.

10. The method of claim 7, wherein the second power source comprises a pulse frequency modulation mode.

11. The method of claim 7, wherein the status of the load comprises the size of the load.

12. A switchable power supply system, comprising:
a power supply comprising a power output terminal connected to a load, wherein the power output terminal of the power supply provides the load with a first power source or a second power source; and
a control circuit disposed in the power supply and connected to the power output terminal for detecting an operating mode of the load,
wherein where the power output terminal of the power supply is forced to provide the load with a first power source when the load is operated in a predetermined operating mode, and
wherein the power output terminal of the power supply is automatically switched to provide the load with the first power source or a second power source according to the status of the load detected by the power output terminal when the load is not operated in the predetermined operating mode.

13. The power supply system of claim 12, wherein the power supply comprises a DC-to-DC power supply.

14. The power supply system of claim 12, wherein the predetermined operating mode comprises a radio frequency emission mode.

15. The power supply system of claim 12, wherein the first power source comprises a pulse width modulation mode.

16. The power supply system of claim 12, wherein the second power source comprises a pulse frequency modulation mode.

17. The power supply system of claim 12, wherein the status of the load comprises the size of the load.

18. A switchable power supply system, comprising:
a power supply comprising a power output terminal connected to a load, wherein the power output terminal of the power supply provides the load with a first power source or a second power source; and
a control circuit disposed in the power supply and connected to the power output terminal for detecting an operating mode of the load,
wherein the power output terminal of the power supply is forced to provide the load with a first power source when the load is operated in a radio frequency emission mode, and
wherein the power output terminal of the power supply system is automatically switched to provide the load with the first power source or a second power source according to the status of the load detected from the power output terminal when the load is not operated in the radio frequency emission mode.

19. The power supply system of claim 18, wherein the power supply comprises a DC-to-DC power supply.

20. The power supply system of claim 18, wherein the first power source comprises a pulse width modulation mode.

21. The power supply system of claim 18, wherein the second power source comprises a pulse frequency modulation mode.

22. The power supply system of claim 18, wherein the status of the load comprises the size of the load.
